(19) United States
(12) Patent Application Publication
(10) Pub. No.: US 2024/0412282 A1
(43) Pub. Date: Dec. 12, 2024

(54) SYSTEMS AND METHODS FOR PERFORMING ONLINE AUCTION TRANSACTIONS

(71) Applicant: Fairbid, Inc., Fredon, NJ (US)

(72) Inventor: Jeremy Miller, Fredon, NJ (US)

(73) Assignee: Fairbid, Inc., Fredon, NJ (US)

(21) Appl. No.: 18/736,992

(22) Filed: Jun. 7, 2024

Related U.S. Application Data
(60) Provisional application No. 63/471,991, filed on Jun. 9, 2023.

(51) Int. Cl. G06Q 30/08; G06Q 20/02

(52) U.S. Cl. CPC G06Q 30/08; G06Q 20/02

(57) ABSTRACT

A direct-to-consumer system for commerce is provided that connects qualified buyers to both sellers and lenders in a singular platform. The platform enables the ability to bid on auction items matched to a buyer's personal and financial criteria and participate in a competitive reverse-bidding platform while having access to real-time indications of how financial decisions affect a buyer's personal finances. Having a singular system that cuts out unnecessary third parties can save both parties time, money, and stress.

### RELATED APPLICATIONS

This application claims the benefit under 35 U.S.C. § 119(e) of U.S. Provisional Application No. 63/471,991, entitled “SYSTEMS AND METHODS FOR A REAL ESTATE ONLINE AUCTION,” filed Jun. 9, 2023, the entire contents of which are incorporated herein by reference.

### FIELD

The field of the invention and its embodiments relates to systems and methods for providing online auctions.

### BACKGROUND

There are many known systems for conducting complex commercial transactions such as real estate transactions. Such systems are disparate and handle many different aspects of a real estate transaction, and each of these systems and processes have their own set of requirements and interfaces relating to these different aspects of the transaction. For example, there are many systems that relate to searching and locating real estate of interest based on user-provided search criteria. However, other aspects of a desired purchase of the transaction, such as financing, closing, and other aspects are handled separately.

### SUMMARY

Described herein are embodiments of a direct-to-consumer system for commerce that connects qualified buyers to both sellers and lenders in a singular platform. The platform enables the ability to bid on auction items matched to a buyer's personal and financial criteria and participate in a competitive reverse-bidding platform while having access to real-time indications of how financial decisions affect a buyer's personal finances. Having a singular system that cuts out unnecessary third parties can save both parties time, money, and stress.

According to one embodiment, a direct-to-consumer system for commerce is provided. The system comprises at least one processor and a plurality of components executable by the at least one processor. The plurality of components comprises a lending application module, an AI optimal matching module, an auction module, a reverse bidding module, and an AI financial analysis module. The lending application module is configured to analyze financial data and determine a bidding approval amount. The AI optimal matching module is configured to match the financial data and personal data with a service provider. The auction module is configured to place a first bid from a buyer. The reverse bidding module is configured to place a second bid from a lender. The AI financial analysis module is configured to analyze a first financial decision of the first bid and analyze a second financial decision of the second bid.

According to one embodiment, an online lending transaction and real estate auction system is provided. The system comprises an application programming interface gateway comprising a processor, a memory, a data storage, a network interface configured for wireless communication, a lender application module, an auction module, and an operating system wherein the operating system is in bidirectional communication with the lender application module and the auction module. The processor is configured to execute steps for receiving, by a lender application module, a loan request initiated by a buyer of a selected real estate property, at least a portion of the loan request being real estate property data and buyer financial data. The data storage is a non-transitory computer-readable medium having programming steps configured for execution on the processor to respond to the loan request, the data storage retains information, the information is configured for implementing at least one financial requirement to determine a value for a loan available of the loan request and a lender provider service based on a validation model from a financial institution. The system further comprises an electronic device, the electronic device having a display, the display is configured to display to the buyer, an approval for the loan having the determined value. The system further comprises a graphic user interface, the graphic user interface is configured to receive input from the buyer.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of an example commerce system 100.

FIG. 2 shows a block diagram of an example online lending transaction auction system 200.

FIG. 3 shows an example flow 300 for a buyer in an example online lending transaction and real estate auction system.

FIG. 4 shows an example flow 400 for an example online lending transaction and real estate auction system.

FIG. 5 shows a block diagram of an example lending application module 500.

FIG. 6 shows a block diagram of an example AI optimal matching module 600.

FIG. 7 shows an example user interface 700 configured to obtain a buyer's personal and financial information.

FIG. 8 shows an example user interface 800 configured to rank a list of at least one match.

FIG. 9 shows an example user interface 900 of at least one match.

FIG. 10 shows an example user interface 1000 of a comparison between at least two matches.

FIG. 11 shows an example user interface 1100 of a comparison between at least three matches.

FIG. 12 shows an example user interface 1200 of at least one match.

FIG. 13 shows a block diagram of an online lending and real estate auction system 1300 configured to schedule an in person visit or view a virtual tour.

FIG. 14 shows a block diagram of an auction module 1400.

FIG. 15 shows a block diagram of a reverse bidding module 1500.

FIG. 16 shows an example flow 1600 for a buyer in an example online lending transaction and real estate auction system.

FIG. 17 shows an example flow 1700 used for a seller in an example online lending transaction and real estate auction system.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

Both buyers and sellers experience challenges with contemporary commerce. Real estate, for example, is a multi-channel industry spread out across a variety of platforms, making it difficult for buyers and sellers to navigate. Buyers are faced with a lack of transparency, often submitting blind offers with no way of knowing if they have made a reasonable offer. Sellers have difficulty vetting qualified buyers. Overall, both buyers and sellers are frustrated with how commerce, specifically within the real estate business, is conventionally conducted. Intermediaries such as realtors are often required to facilitate transactions between a buyer and seller, causing transaction delays and increasing overall costs. Although real estate is used as an example, there are other commercial industries where the commerce process is non-optimal, leading to unsatisfactory experiences.

The inventors have appreciated that an efficient system to facilitate commerce is not fully realized. The current structure of the industry model is a source of stress and low satisfaction for both buyers and sellers. The inventors have further appreciated that increased satisfaction may be achieved by pairing a community of fully-vetted, qualified buyers with the ability to bid on auction items matched to their personal and financial criteria, participate in a competitive reverse-bidding platform, all while all while having access to meaningful, real-time indication of how financial decisions affect their personal finances. Having a singular system and platform that cuts out unnecessary third parties can connect a buyer directly to a seller, saving both parties time, money, and stress.

Many conventional online auction systems and methods for real estate property exchange include the step of registering at least one seller and at least one buyer with the platform application. Each of the sellers may list a plurality of properties for sale. A buyer may search for a property based on location and/or cost range. The buyer may view photos, take a virtual tour, and/or bid on a property within a preset time period. It is known for these existing online auction systems to determine a winning buyer, such as who has the highest bid at the end of the preset time period. These existing systems are not configured for a buyer to be qualified based on a buyer's desired real estate property selection, for a loan and/or matched with a lender. Many buyers are borrowers and have a need for competitive contract terms for a loan from a lender. Thus, it would be more desirable for an online auction system to be configured to offer a buyer an option to select from a plurality of competitive contract terms from a plurality of lenders. As a result, a buyer would be fully underwritten prior to an online auction real estate purchase, and payment arrangements for a winning bid could be configured with a desired financial institution. A lender hub allows lenders to bid on a buyer with the loan fully approved before the lender bids.

In general, at least some aspects of the present invention and its embodiments relate to a platform to match fully qualified buyers with sellers at reduced cost (e.g., half the cost. Third parties that facilitate interactions between a buyer and a seller are often compensated through commission. A realtor, for example, will profit by acquiring a percentage of a home's selling price. By removing the need for third parties such as a realtor, both parties will benefit: sellers will make more money and buyers will save money.

A transparent bidding system can save further costs for a buyer. In terms of real estate, buyers will put in blind offers unaware of what other potential buyers are also bidding. For example, a buyer may bid $50,000 more than any other potential buyer has bid. Or, on the contrary, a buyer may have missed out on a sale by $1,000 and would have offered a higher bid if they were aware of bids by other potential buyers. Transparent bidding increases fairness and access for all potential buyers. Having the ability to see the current highest offer informs buyers, allowing them to make more educated financial decisions.

Having an all-in-one commerce platform that is more personalized to a user's needs is currently unrealized. The direct-to-consumer model of the platform cuts out unnecessary third parties, providing a direct connection between buyers and sellers and yielding a more well-regulated, organized platform for users. Individualizing the system allows a user to make smarter, more informed personal and financial decisions. For example, based on extensive data collection, the system may match a user with service providers that fit both their personal and financial needs. The system may also provide real time indications analyzing a user's potential financial decisions.

It is within the scope of this invention for the term “seller” or “seller's representative” to be anyone acting on behalf of a seller and/or a potential seller including, but not be limited to, a broker of a seller, a property manager of a seller, and/or a seller.

It is within the scope of this invention for the term “buyer” or “buyer's representative” to be anyone acting on behalf of a buyer and/or potential buyer including, but not limited to, a broker of a buyer, a potential buyer, a borrower, and/or a buyer. These and other important objects, advantages, and features of the invention will become clear as this description proceeds.

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context dearly indicates otherwise.

The phrase “and/or,” as used herein in the specification and in the claims, should be understood to mean “either or both” of the elements so conjoined, i.e. elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A): in yet another embodiment, to at least one, optionally including more than one, A, and at least one, optionally including more than one, B (and optionally including other elements); etc.

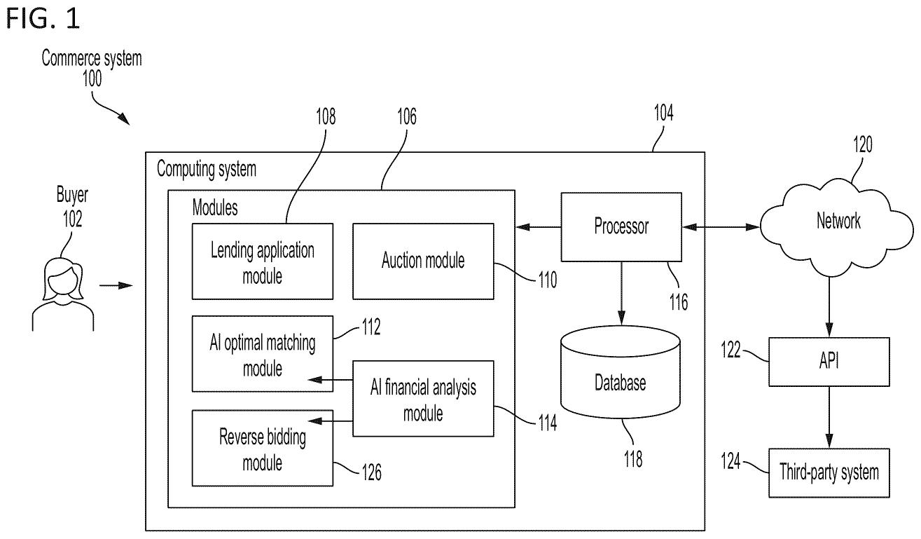

FIG. 1 illustrates an example of a direct-to-consumer model configured for commerce. In some embodiments a system for commerce 100 may allow a buyer 102 to access computing system 104 on a web application or mobile application. The computer system 104 may comprise modules 106, processor 116, and database 118. Processor 116 may be configured to execute processor-executable instructions stored in a non-transitory computer-readable storage media. In some embodiments, processor 116 may be in communication with at least one database 118. For example, the at least one database 118 may contain financial and personal data of a buyer and/or seller. In some embodiments, processor 116 may be in communication with modules 106. For example, modules 106 may include a lending application module 108, auction module 110, artificial intelligence (AI) optimal matching module 112, AI financial analysis module 114, and reverse bidding module 126. For example, lending application module 108 may be configured to analyze data associated with a buyer's financial information and determine a buyer's bidding approval amount; auction module 110 may be configured to for a buyer to place a bid; AI optimal matching module 112 may be configured to match a buyer's personal and financial needs with service providers; AI financial analysis module 114 may be configured to provide real time indications analyzing a user's potential financial decisions in combination with AI optimal matching module 112 and/or reverse bidding module 126; and reverse bidding module 126 may be configured for a lender to place a bid to compete for a buyer's business. In some embodiments processor 116 may be in bidirectional communication with network 120. Processor 116 may transmit and receive data from modules 106 and the at least one database 118 over network 120 to at least one third party system 1224 through at least one API 122. For example, the third-party system may be a system configured to determine a buyer's bidding approval amount, a scheduling system, a job searching system, and/or a system configured extract financial information from the uploaded documents.

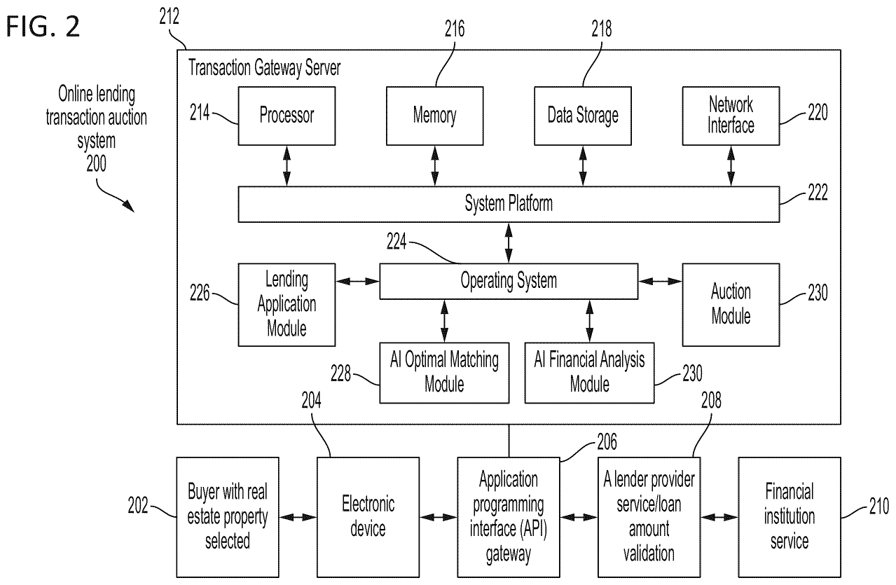

FIG. 2 depicts an online lending transaction auction system 200. Buyer 202 selects a desired real estate property using an interface on the electronic device 204. Electronic device 204 is in bidirectional communication with API gateway 206. A lender provider service 208 is configured to pair a lender with a potential buyer of a real estate property. The lender may view the approved loan amount of a potential buyer and may also view contract terms offered to the potential buyer by a third party. Financial institution service 210 is in bidirectional communication with lender provider service. API gateway 206 has transaction gateway server 212 having a processor 214, memory 216, data storage 218, and network interface 220 enabling web communications through platform 222. The server operating system 224 enables the operation of lending application module 226, AI optimal matching module 228, AI financial analysis module 230, and real estate auction module 230. The system may be embodied as a web application, mobile application, or dedicated software (SAAS, etc.).

In accordance with the principles and embodiments of the present invention, a system may include a transaction gateway server having a processor, a memory, a data storage, a network interface configured for wireless communications, a lender application module, an auction module, and an operating system. The operating system is in bidirectional communication with the lender application module and the auction module. A system may include the processor being configured to execute steps for receiving, by the lender application module, a loan request initiated by a buyer of a selected real estate property, at least a portion of the loan request being real estate property data, and buyer financial data. A system may include the data storage being a non-transitory computer-readable medium having program steps configured for execution on the processor to respond to the loan request, the data storage retains information, the information is configured for implementing at least one financial requirement to determine a value for a loan available of the loan request and a lender provider service based on a validation model from a financial institution system. A system may include the system platform in wireless and/or a wired communication with an electronic device having a display. The display is configured to display to the buyer, an approval for the loan having the determined value. A system may include an electronic device having a graphic user interface, the graphic user interface is configured to receive input from the buyer, and which also includes improvements that overcome the limitations of prior real estate auction platforms, is now met by a new, useful, and non-obvious invention.

In some aspects, the techniques described herein relate to an online lending transaction and real estate auction system, including: an application programming interface (API) gateway, including: a transaction gateway server, the transaction gateway server, including: a processor; a memory; a data storage; a network interface configured for wireless communications; a lender application module; an auction module; and an operating system, the operating system is in bidirectional communication with the lender application module and the auction module; the processor is configured to execute steps for receiving, by the lender application module, a loan request initiated by a buyer of a selected real estate property, at least a portion of the loan request being real estate property data and buyer financial data; the data storage is a non-transitory computer-readable medium having program steps configured for execution on the processor to respond to the loan request, the data storage retains information, the information is configured for implementing at least one financial requirement to determine a value for a loan available of the loan request and a lender provider service based on a validation model from a financial institution; an electronic device, the electronic device having a display, the display is configured to display to the buyer, an approval for the loan having the determined value; and a graphic user interface, the graphic user interface is configured to receive input from the buyer.

In at least one embodiment, there is an online lending transaction and real estate auction system, comprising: an application programming interface (API) gateway, comprising: a transaction gateway server, the transaction gateway server, comprising: a processor; a memory; a data storage; a network interface configured for wireless communications; a lender application module; an auction module; and an operating system, the operating system is in bidirectional communication with the lender application module and the auction module; the processor is configured to execute steps for receiving, by the lender application module, a loan request initiated by a buyer of a selected real estate property, at least a portion of the loan request being real estate property data and buyer financial data; the data storage is a non-transitory computer-readable medium having program steps configured for execution on the processor to respond to the loan request, the data storage retains information, the information is configured for implementing at least one financial requirement to determine a value for a loan available of the loan request and a lender provider service based on a validation model from a financial institution; an electronic device, the electronic device having a display, the display is configured to display to the buyer, an approval for the loan having the determined value; and a graphic user interface, the graphic user interface is configured to receive input from the buyer.

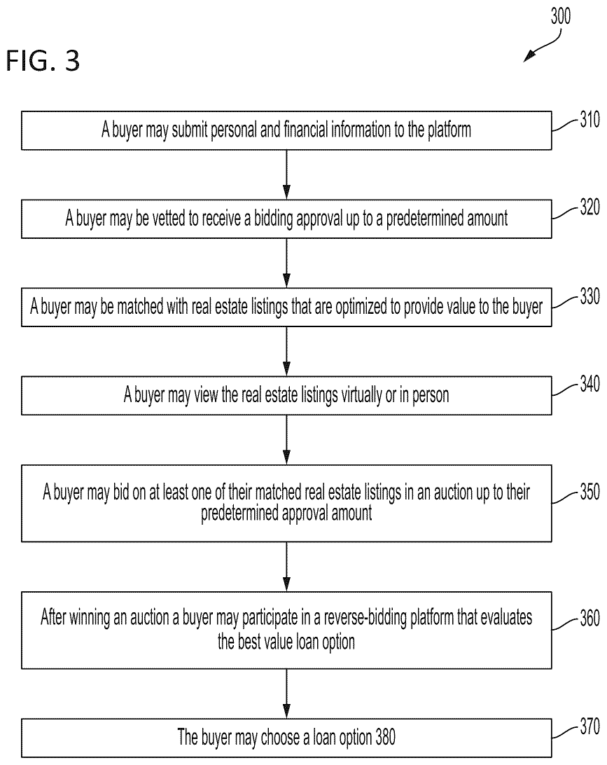

FIG. 3 illustrates a method 300 of various actions that may be performed by a buyer in an online lending transaction and real estate auction system according to a nonlimiting embodiment of the present application. In some embodiments a buyer may submit personal and financial documentation to the platform 310. Using data from the personal and financial documentation submitted by a buyer to the platform, a buyer may be vetted to receive a bidding approval up to a predetermined amount 320. Using data from the personal and financial documentation submitted by a buyer to the platform and the predetermined approval amount, a buyer may be matched with real estate listings that are optimized to provide value to the buyer 330. A buyer may view the real estate listings virtually or in person 340. A buyer may bid on at least one of their matched real estate listings in an auction up to their predetermined approval amount 350. After winning an auction a buyer may participate in a reverse-bidding platform that evaluates the best value loan option 360. The buyer may choose a loan option 370.

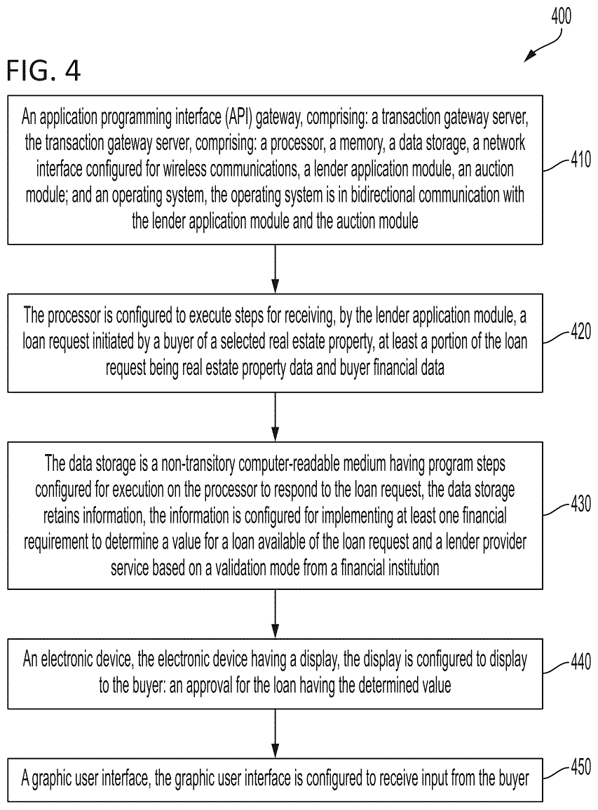

FIG. 4 is a flowchart of an example method for an online lending transaction and real estate auction system 400. At step 410, an application programming interface (API) gateway, comprising: a transaction gateway server, the transaction gateway server, comprising: a processor, a memory, a data storage, a network interface configured for wireless communications, a lender application module, an auction module; and an operating system, the operating system is in bidirectional communication with the lender application module and the auction module. At step 420, the processor is configured to execute steps for receiving, by the lender application module, a loan request initiated by a buyer of a selected real estate property, at least a portion of the loan request being real estate property data and buyer financial data. At step 430, the data storage is a non-transitory computer-readable medium having program steps configured for execution on the processor to respond to the loan request, the data storage retains information, the information is configured for implementing at least one financial requirement to determine a value for a loan available of the loan request and a lender provider service based on a validation model from a financial institution. At step 440, an electronic device is provided. The electronic device having a display, the display is configured to display to the buyer, an approval for the loan having the determined value. At step 450, a graphic user interface is provided. The graphic user interface is configured to receive input from the buyer.

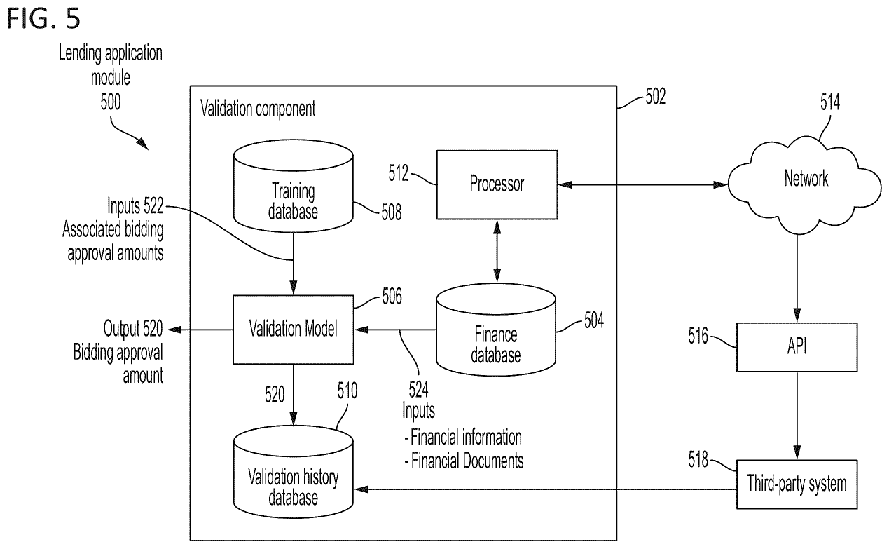

FIG. 5 is a block diagram of system elements and process flow, according to one embodiment of an example lending application module 500. The lending application module 500 can be configured to analyze data associated with a buyer's financial information and determine a buyer's bidding approval amount.

According to some embodiments, at least one finance database may store data associated with a buyer's financial information. A buyer may input their financial information into the system. For example, a buyer may be prompted to fill out a survey or upload documents representing their financial information. Financial information may include, for example, household income, variable and fixed monthly expenses such as insurance and debt payments, as well as monthly savings goals. Financial documents may include, for example, financial statements such as a W2 document, pay statements, and bank statements. In some embodiments, the system may include an application programming interface (API) configured to allow at least one third-party system to extract financial information from the uploaded documents through optical character recognition. The extracted financial information may be stored as data in the at least one finance database.

According to some embodiments, the lending application module 500 may include a validation component 502 configured to analyze data and determine a buyer's bidding approval amount. In some embodiments, machine learning analysis may be performed on data stored in the at least one finance database 504 and the at least one training database 508. In one example, the machine learning model validation model 506 can be trained on data 524 stored in the at least one finance database 504 and associated bidding approval amounts 522. The associated bidding approval amounts may be stored in training database 508. The validation model 506 may be configured to identify a buyer's bidding approval amount 520. The output 520 of the validation model 506 can be stored in a validation history database 510. The buyer may be identified as a qualified buyer upon receiving a bidding approval amount.

According to other embodiments, validation component 502 may utilize a third-party system to analyze the data associated with the buyer's financial information. Processor 512 may transmit and receive data from the at least one finance database 504 over network 514 to at least one third party system 518 through an API 516. The at least one third party system 518 may identify a buyer's bidding approval amount. The buyer's bidding approval amount identified by the third-party system 518 may be stored in a validation history database 510. The buyer may be identified as a qualified buyer upon receiving a bidding approval amount.

According to some embodiments, the lender application module 500 may be performed in an online lending transaction auction system according to a nonlimiting embodiment of the present application. For example, based on input data from a buyer, being a potential borrower, the system determines the amount of money the potential borrower is approved for in relation to a potential purchase of desired real estate property.

When the data is input into the system by a buyer, the approval process determines a value of an increment that the buyer is eligible for receiving as a loan from a lender. A lender includes, but is not limited to, an individual, a public group, a private group, and/or a financial institution that makes funds available to a borrower such as an individual, a buyer, a person and/or a business entity with the expectation that the funds will be repaid. Repayment includes, but is not limited to, the payment of any interest or fees and may occur in increments such as, in a monthly mortgage payment and/or as a lump sum. In some embodiments, the mortgage payments may be able to be made directly through the system or by utilizing a plug-in or similar software to allow for the same.

The platform is configured for fully underwritten live bidding. It is within the scope of this invention for fully underwritten bidding to include, but not be limited to, a buyer being one hundred percent qualified to make a purchase up to a predetermined amount. The predetermined amount is determined by the system and is based on input submitted by the buyer during the platform registration process. A validation module and a referenced title module are portions of the system. The system is configured for the lending operation process to include, but not be limited to, the general areas of a lending operation such as, loan origination, risk evaluation, credit decisioning, underwriting, collateral management, debt collection, loan servicing, and/or reporting.

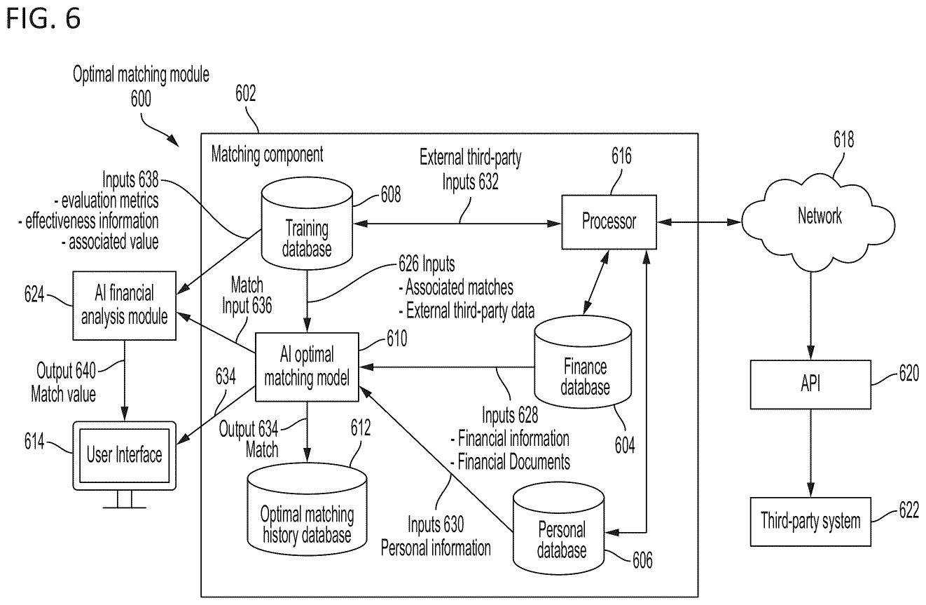

FIG. 6 is a block diagram of system elements and process flow, according to one embodiment of an example AI optimal matching module 600. The AI optimal matching module 600 may be configured to match a buyer's personal and financial needs with service providers.

According to some embodiments, at least one finance database may store data associated with a buyer's financial information and at least one personal database may store data associated with a buyer's personal information. A buyer may input their financial and personal information into the system. For example, a buyer may be prompted to fill out a survey or upload documents representing their financial and personal information.

In the example of an online lending transaction and real estate auction system, personal information may include both close-ended and open-ended questions. Close-ended questions may include standard criteria such as ideal square footage, number of bedrooms and bathrooms, preferred location, type of property (i.e., house, apartment, condo, etc.), preferred amenities (i.e., pool, outdoor space, garage, in unit laundry, parking spot included, etc.). Close-ended questions may also include questions about the buyer's personal life such as their occupation and hobbies. Open-ended questions may include asking a buyer how important it is to be located close to their family, what their opinion is of hybrid, remote, and in person work, the style of home they are most interested in (i.e. if they want a cape-style house, an updated kitchen, new flooring, etc.), how important it is to live in a top-rated school district, is they have any accessibility requirements, preferences regarding proximity to public transportation (i.e., within walking distance of the subway system, within a 5 minute drive of a major highway, etc.), preferences regarding proximity to shopping centers or recreational activities, as well as preferences regarding environmental noise (i.e., considering the importance of being in a quiet neighborhood vs. being located on a main street).

In the example of an online lending transaction and real estate auction system, financial information may include, for example, household income, variable and fixed monthly expenses such as insurance and debt payments, as well as monthly savings goals. Financial documents may include, for example, financial statements such as a W2 document, pay statements, and a buyer's bank account information. In some embodiments, the system may include an API configured to allow at least one third-party system to extract financial information from the uploaded documents through optical character recognition. The extracted financial information may be stored as data in the at least one finance database.

According to some embodiments, the AI optimal matching module 600 may include a matching component 602 configured to analyze data and determine at least one match. In some embodiments, machine learning analysis may be performed on data stored in the at least one finance database 604, the at least one personal database 606, and the at least one training database 608. In one example, the machine learning model optimal matching model 610 can be trained on data 628 stored in the at least one finance database 604 (including verification a user is a qualified buyer and a buyer's bidding approval amount), data 630 stored in the at least one personal database 606, associated matches 626, as well as external data 632 accessed from a third-party system. The associated matches may be stored in training database 608. Processor 616 may transmit and receive data 632 from the training database 608 over network 618 to the at least one third party system 622 through an API 620. For example, the external data accessed from a third-party system may be a listing of posted job opportunities. The AI optimal matching model 610 may be configured to determine at least one match. The at least one match may be real estate listings, for example. The output 634 of the AI optimal matching model 610 can be stored in an optimal matching history database 612. The output 634 of the AI optimal matching model 610 may be displayed on a user interface 614 to the buyer on a web application or mobile application.

According to some embodiments, matching component 602 may access AI financial analysis module 624 to evaluate the value of each match outputted by the AI optimal matching model 610. The value of each match may indicate to a buyer to what extent their personal and financial goals compare to each respective match. In this example, the machine learning model AI financial analysis module 624 can be trained on each match 636 outputted by the AI optimal matching model 610 and inputs 638: evaluation metrics, effectiveness information, and associated value. The evaluation metrics, effectiveness information, and associated value may be stored in training database 608. The AI financial analysis model 624 may be configured to output 640 the value of each match.

In some embodiments, the value of each match determined by the AI financial analysis model 624 may indicate how a match impacts a buyer's financial information and quality of life. Alternatively or additionally, the output of the AI financial analysis model 624 may be displayed on a user interface 614 to the buyer on a web application or mobile application. For example, each match may be labeled to indicate if the match is high value, medium value, or low value to the buyer. In a further example, each match may be color-coded (e.g., green, yellow, or red) to indicate if the match is of high value, medium value, or low value to the buyer, respectively. In yet a further example, a value list may be displayed to the buyer to detail why a match may or may not provide value to a buyer. In yet a further example, a value statement may be displayed to detail to the buyer reasons why a match may or may not provide value to a buyer.

In some embodiments, the AI optimal matching module can be configured to send automated notifications to a buyer indicating a new match. Processor 616 may transmit and receive data from the AI optimal matching model 610 over network 618 to the at least one third party system 622 through an API 620. For example, a user may request to be notified through text messaging, email services, automated phone calls, etc. every time a new high value match has been determined. The AI optimal matching module 600 may include at least one API to trigger at least one third-party system and notify the buyer of a new match.

According to some embodiments, the AI optimal matching module 600 may be performed in an online lending transaction auction system according to a nonlimiting embodiment of the present application. For example, the platform is further configured to match users'financial needs with service providers (e.g., attorneys, contractors, banks, landscaping, refinancing, etc.) for the purchase of a home or other goods/services. The users will be able to bring their fully underwritten pre-approval to the platform to provide lenders and/or service providers with confidence in the ability of the user to complete the transaction. Alternatively or additionally, the platform may be configured to evaluate a buyer as a qualified buyer and identify a bidding approval amount. This is preferably a requirement of the system to allow lenders and other service providers to bid on their services for potential user selection. Further, according to some embodiments, the system will not allow bids over the maximum approval amount for any loan. Finally, in some implementations, all funds will be verified at the time the bid is made by the party. Thus, buyers know what to bid and sellers know they are getting top dollar for their property.

It is within the scope of this invention for the system to perform a method of bidding for real estate purchases. In particular, a software platform is provided. A user having a desire to purchase or rent a piece of real estate including, but not limited to, land and/or a building, would be able to input data into the system for both owners and renters/landlords. In some embodiments, there may be rent-to-own options.

The platform displays a plurality of property listings from at least one individual including, but not limited to, an agent, a seller, an individual, and/or a business entity.

It is within the scope of this invention for data to include, but not be limited to, a selected real estate property, a location of a real estate property, and/or the financial information of a buyer.

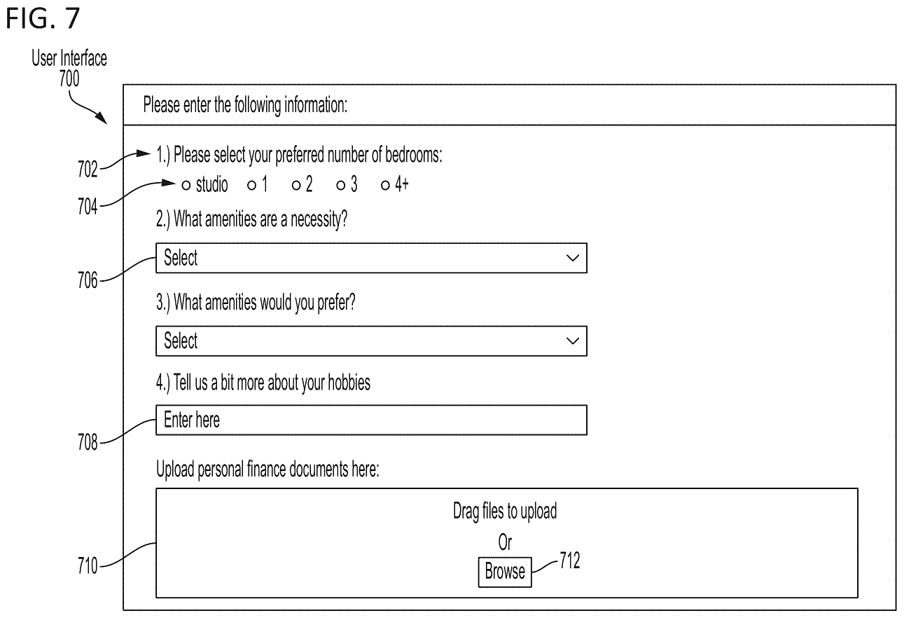

FIG. 7 is an example user interface according to one embodiment of the example AI optimal matching module of FIG. 6. According to the embodiment of FIG. 6, a buyer input both their personal and financial information into the system. To obtain a buyer's personal and financial information, a buyer may be prompted to fill out a survey, displayed on a web application or mobile application through user interface 700. In some embodiments, the system prompts the buyer with at least one question 702. For example, the question 702 may prompt a buyer in the form of a multiple-choice option 704. For example, the question 702 may ask the buyer to select one or more options in the form of a drop-down menu 706. For example, the question 702 may prompt the buyer to type their response 708. In some embodiments, the system may allow the buyer to upload pertinent information into the system. For example, the buyer may drag and drop their documents into a drop zone 710. For example, the buyer may press a button 712 to upload their documents.

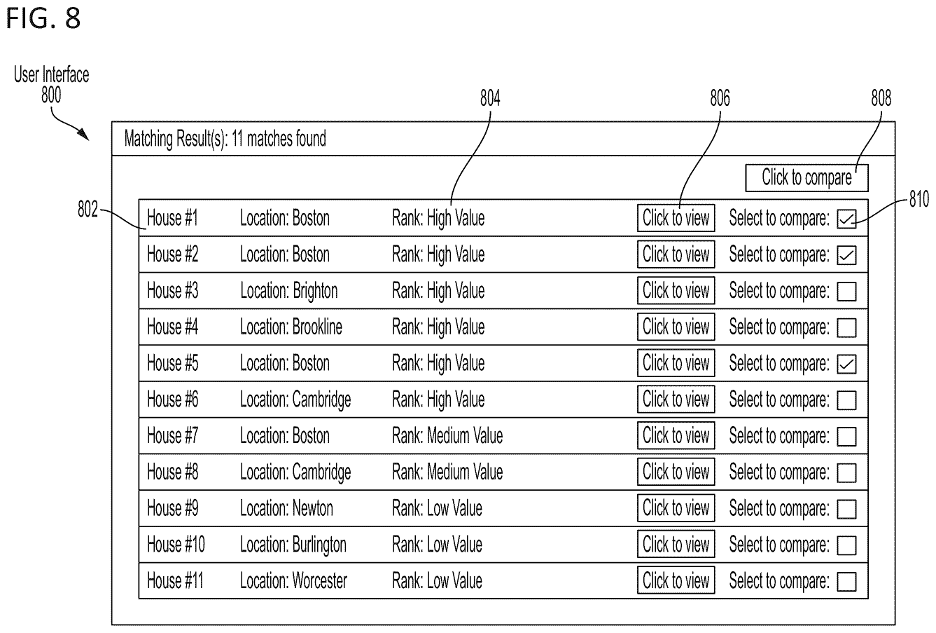

FIG. 8 is an example user interface according to one embodiment of the example AI optimal matching module of FIG. 6. According to the embodiment of FIG. 6, a buyer may receive a ranked list of at least one match 802. The ranked list may be displayed on a web application or mobile application through user interface 800. In some embodiments, each match 802 may be labeled to indicate an output value 804 of the match (i.e., if the match is high value, medium value, or low value). If the match is high value, it will be ranked closer to the top of the user interface. If the match is low value, it will be ranked closer to the bottom of the user interface. In some embodiments, the buyer may be able to click a button 806 and view details of the match 802. For example, the system may provide the buyer with a value list and/or value statement indicating reasons why the match has a particular rank. In some embodiments, the buyer may be able to select 810 at least one match and at least a second match and click a button 808 to compare details of the at least one match with at least a second match. The system may provide the buyer with at least two respective value lists and/or a value statement indicating reasons why the respective matches have a particular rank, as well as recommend which match is more favorable to the buyer's personal and financial goals.

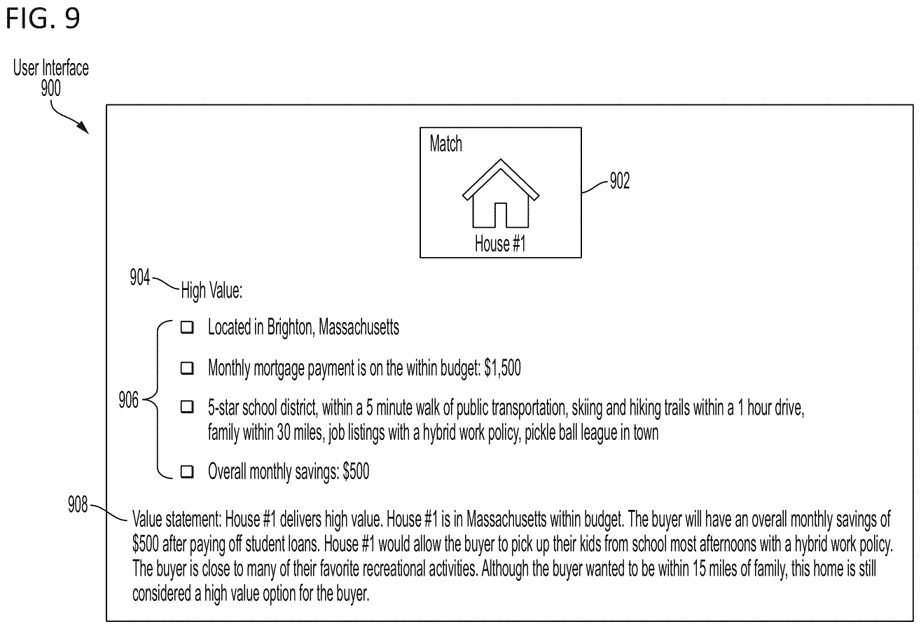

FIG. 9 is an example user interface according to one embodiment of the example AI optimal matching module of FIG. 6. According to the embodiment of FIG. 6, the output of the AI optimal matching model 610 and the output of the AI financial analysis model 624 may be displayed on a web application or mobile application through user interface 900. In this example, the value of match 902 is analyzed. Match 902 may be labeled on user interface 900 as a high value match 904. Alternatively or additionally, user interface 900 may display a value list 906 and/or value statement 908 that indicate reasons why match 902 is labeled as high value.

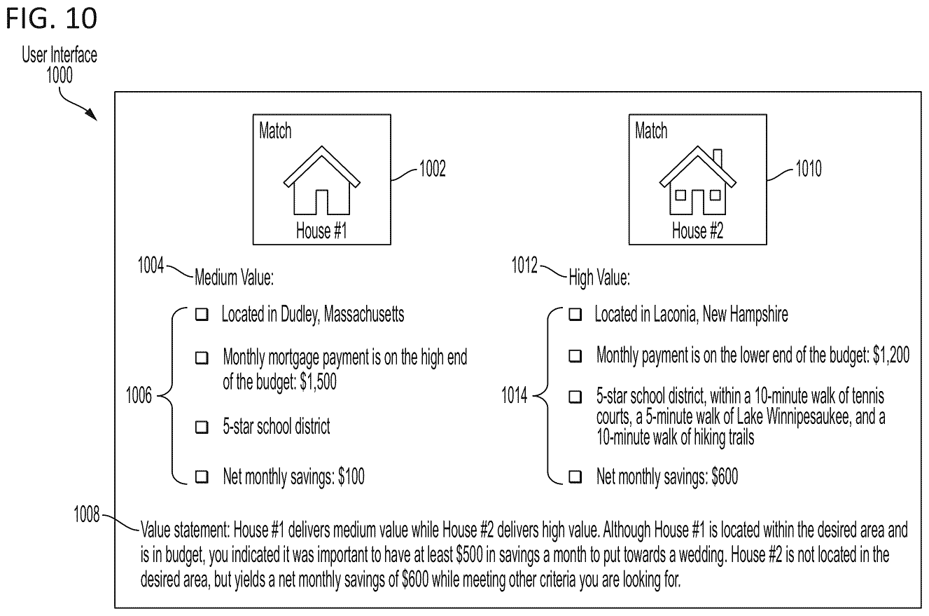

FIG. 10 is an example user interface according to one embodiment of the example AI optimal matching module of FIG. 6. According to the embodiment of FIG. 6, the output of the AI optimal matching model 610 and the output of the AI financial analysis model 624 may be displayed on a web application or mobile application through user interface 1000. In this example, a side-by-side comparison of the value of match 1002 and the value of match 1010 is displayed. Match 1002 may be labeled on user interface 1000 as a medium value match 1004. Match 1010 may be labeled on user interface 1000 as a high value match 1012. Alternatively or additionally, user interface 1000 may compare a value list 1006 to a value list 1014. Value list 1006 may indicate reasons why match 1002 is labeled as medium value. Value list 1012 may indicate reasons why match 1010 is labeled as high value. Alternatively or additionally, value statement 1008 indicates why matches 1002 and 1010 are labeled as medium value and high value matches, respectively. Value lists 1006 and 1012 and value statement 1008 may indicate a net monthly savings, making it easy for a buyer to understand their financial situation.

In some embodiments, the AI financial analysis model 624 may provide a high value match recommendation that optimizes a buyer's personal and financial needs. Alternatively or additionally, the AI financial analysis model 624 may provide a high value match recommendation that deviates from a buyer's personal and financial needs. For example, a buyer may indicate they want to meet a monthly saving goal. As shown in FIG. 8, the buyer's monthly saving goal is $500 a month. Although match 810 is not located in the buyer's desired location and deviates from the buyer's personal needs, the AI financial analysis model 624 indicates match 810 is a high value match. For example, the location of match 810 may collect less money in state taxes than the location of match 802. If a buyer was to move to a state that collects less money in taxes, the monthly tax savings would allow the buyer to still achieve their monthly savings goal. To this end, the AI model may be trained on information outside of the transaction and therefore may return a more accurate match for the buyer. Additionally, as shown in FIG. 8 by value list 814, match 810 meets further criteria of the buyer.

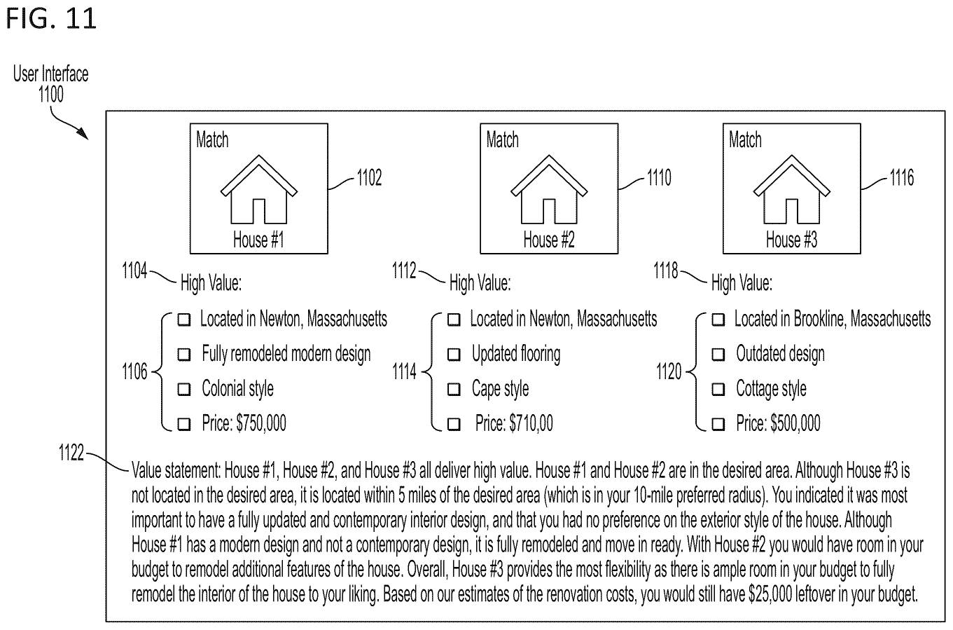

FIG. 11 is an example user interface according to one embodiment of the example AI optimal matching module of FIG. 6. According to the embodiment of FIG. 6, the output of the AI optimal matching model 610 and the output of the AI financial analysis model 624 may be displayed on a web application or mobile application through user interface 1100. In this example, a side-by-side comparison of the value of match 1102, the value of match 1110, and the value of match 1116 is displayed. Match 1102 may be labeled on user interface 1100 as a high value match 1104. Match 1110 may be labeled on user interface 1100 as a high value match 1112. Match 1118 may be labeled on user interface 1100 as a high value match 1118. Alternatively or additionally, user interface 1100 may compare a value list 1106 to a value list 1114 to a value list 1120. Value list 1106 may indicate reasons why match 1102 is labeled as high value. Value list 1114 may indicate reasons why match 1110 is labeled as high value. Value list 1120 may indicate reasons why match 1116 is labeled as high value. Alternatively or additionally, value statement 1122 indicates why matches 1102, 1110, and 1116 are labeled as high value matches. Value lists 1106, 1114, and 1120, and value statement 1122 may indicate a net monthly savings, making it easy for a buyer to understand their financial situation.

In some embodiments, the AI financial analysis model 624 may provide a high value match recommendation that optimizes a buyer's personal and financial needs. Alternatively or additionally, the AI financial analysis model 624 may provide a high value match recommendation that deviates from a buyer's personal and financial needs. For example, a buyer may indicate they want to meet a monthly saving goal. As shown in FIG. 11, the buyer's priority is to have a fully remodeled and contemporary interior design. Although match 1116 is not located in the buyer's desired location, the AI financial analysis model 624 indicates match 1116 is a high value match. For example, the buyer indicated a preferred location of Brookline, Massachusetts with a 10-mile radius margin. Match 1116 is located within 10 miles of Brookline. Even though match 1116 has an outdated interior, the price is significantly under budget and will give the buyer an opportunity to customize the design of the house to their liking. Additionally, as shown in FIG. 11 by value statement 1122, matches 1102 and 1110 meet many of the further criteria of the buyer.

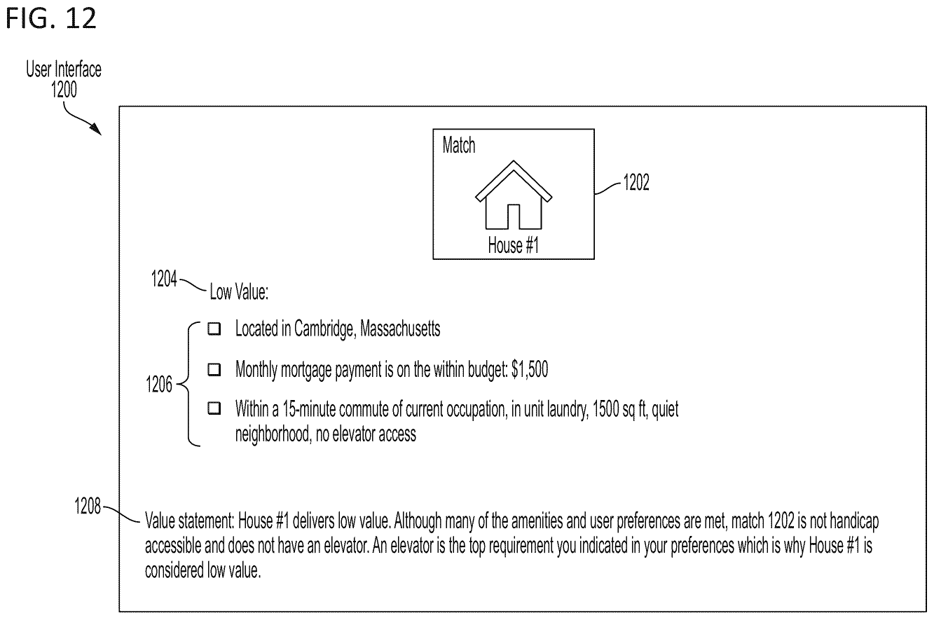

FIG. 12 is an example user interface according to one embodiment of the example AI optimal matching module of FIG. 6. According to the embodiment of FIG. 6, the output of the AI optimal matching model 610 and the output of the AI financial analysis model 624 may be displayed on a web application or mobile application through user interface 1200. In this example, the value of match 1202 is analyzed. Match 1202 may be labeled on user interface 1200 as a low value match 1204. Alternatively or additionally, user interface 1200 may display a value list 1206 and/or value statement 1208 that indicate reasons why match 1202 is labeled as low value.

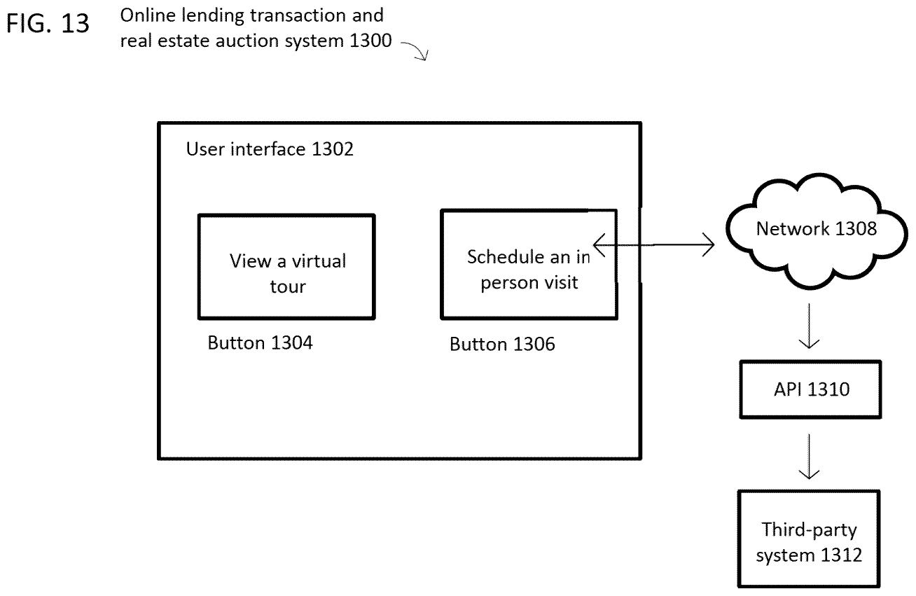

FIG. 13 is a block diagram of system elements and process flow, according to one embodiment of an online lending transaction and real estate auction system 1300. According to some embodiments, button 1304 and button 1306 may be made available to a user through user interface 1302. If a buyer selects button 1304, they may view a virtual tour of the match. If a buyer selects button 1306, they may be prompted to schedule an in-person tour of the match. A processor (not shown) may transmit and receive data over network 1308 to the at least one third-party system 1312 through an API 1310. For example, the third-party system may be a scheduling system.

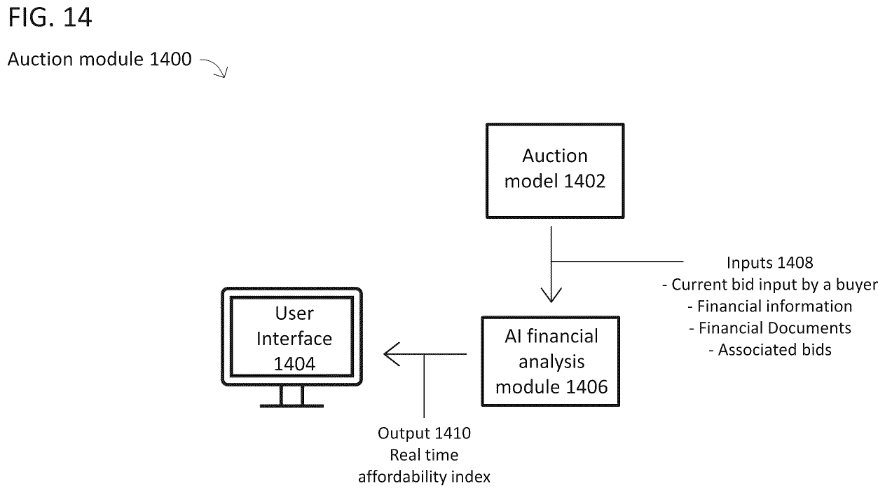

FIG. 14 is a block diagram of system elements and process flow, according to one embodiment of an example auction module 1400. The auction module 1400 is configured for a user, such as a buyer, to place a bid. It is within the scope of this invention for the system to allow for anonymous bidding and/or transparent bidding. When a bidder bids on a house, for example, the winning bid prompts the buyer to pay when the house sells.

According to some embodiments, auction model 1402 may be configured to perform an auction on a listing. The auction may be displayed on user interface 1404 to the buyer on a web application or mobile application. The listing, for example, may be real estate. The seller may indicate the start time of the auction, the duration of the auction, and the end time of the auction. Each respective buyer may place a bid on the listing within the duration of the auction. Each respective buyer may place a plurality of bids on the listing. The auction duration may auto-extend by an amount specified by the seller if a buyer places a bid within an auto-extend period. For example, if a buyer places a bid in the last 30 minutes of an auction, a seller may specify that the auction be extended by 5 minutes. Auto-extending a bid may prevent a buyer from placing a last-minute bid on the listing. In some embodiments, each time a buyer places a bid, the bid amount may be displayed to each respective buyer on user interface 1404. A transparent auction may create an objective and fair system for buyers. The winning bid may be the highest bid placed by a buyer at the end of the duration of the auction.

According to some embodiments, auction model 1402 may access AI financial analysis module 1406 to provide a real time affordability index to a buyer. A real time affordability index may indicate to each buyer how a bid affects their personal finances. In some embodiments, each time a bid is placed in an auction, a real time affordability index may be displayed on user interface 1404 indicating an estimated monthly payment for a buyer. In this example, the AI financial analysis module 1406 can be trained on inputs 1408: the current bid input by a buyer, financial information, financial documents, and associated bids. The AI financial analysis module 1406 may be configured to output a real time affordability index 1410 of the current bid.

Alternatively or additionally, each bid may be color coded green, yellow, or red to indicate to each respective buyer if placing a bid is advantageous to their personal finances. For example, AI financial analysis module 1406 may indicate that an ideal monthly payment for a buyer is between $1,000 and $1,500. A real time affordability index displayed on user interface 1404 may indicate a monthly payment for the current bid is $1,100. The real time affordability index may be green to represent that the current monthly payment is advantageous to a buyer's personal finances. If an additional bid is made, the real time affordability index displayed on user interface 1404 may update to indicate the current monthly payment for the current bid. If the real time affordability index indicates a monthly payment is $1,450, the real time affordability index may be yellow. Yellow may represent that the current monthly payment is getting close to the high end of a buyer's bidding approval amount. The real time affordability index may be red to represent that the current monthly payment surpasses the buyer's bidding approval amount. If the current monthly payment surpasses the buyer's bidding approval amount, the auction model 1002 may prevent a buyer from placing a bid.

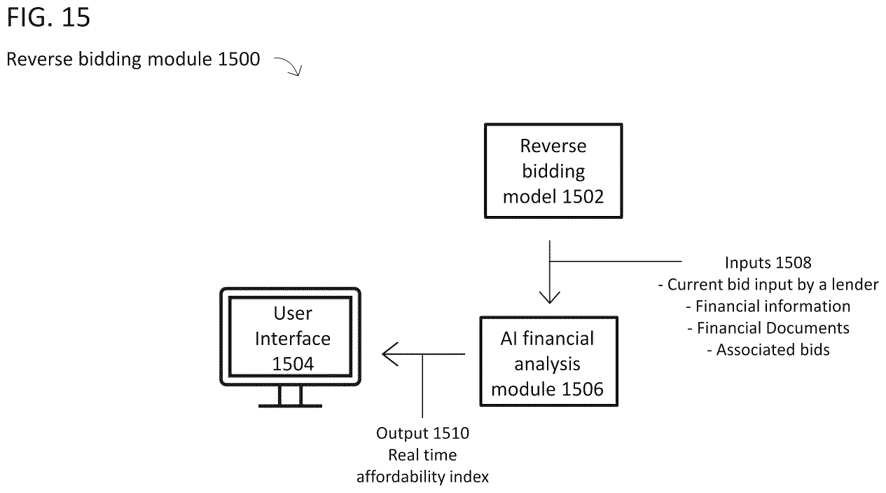

FIG. 15 is a block diagram of system elements and process flow, according to one embodiment of an example reverse bidding module 1500. The reverse bidding module 1500 is configured for a lender to place a bid to compete for a buyer's business.

According to some embodiments, reverse bidding model 1502 may be configured to perform a bid for a lender. The reverse bidding may be displayed on user interface 1504 to the buyer on a web application or mobile application. The listing, for example, may be real estate. The buyer may indicate the start time and end time of the reverse bid. The duration of a reverse bid may be automatically set to a specified time (e.g., 24 hours). Each respective lender may place an offer to the buyer within the duration of the auction. Each respective lender may place a plurality of bids for the buyer. In some embodiments, each time a lender places a bid, the bid amount may be displayed to the respective buyer on user interface 1504. A transparent auction may create an objective and fair system for buyers. The buyer may select the winning bid after the end time of the reverse bid.

According to some embodiments, reverse bidding model 1502 may access AI financial analysis module 1506 to provide a real time affordability index to a buyer. A real time affordability index may indicate to each buyer how a bid affects their personal finances. In some embodiments, each time a bid is placed in a reverse bid, a real time affordability index may be displayed on user interface 1504 indicating an estimated monthly payment for a buyer. In this example, the AI financial analysis module 1506 can be trained on inputs 1508: the current bid input by a lender, financial information, financial documents, and associated bids. The AI financial analysis module 1506 may be configured to output a real time affordability index 1510 of the current bid. Alternatively or additionally, each bid may be color coded green, yellow, or red to indicate to the buyer if a bid is favorable, indifferent, or unfavorable to their personal finances. If an additional bid is made, the real time affordability index displayed on user interface 1504 may additionally indicate the current monthly payment for the additional bid.

In practice, a user of the system inputs all of the requisite information into the platform in order to receive bids from lenders. For example, once the user is satisfied with the completeness and accuracy of the inputted information, the user can select/click to send the mortgage financing bid to the platform to allow any number of lenders to bid on the profile submitted by the user. The lenders will have up to twenty-four (24) hours to submit bids, after which the user can click to select a particular bid from a particular lender given the terms that the user desires. In some embodiments, the lenders can submit multiple bids depending on the bids received from other lenders in an effort to put forth the most attractive offer to the user in order to solicit the user's business. Ultimately, it is up to the lender to put forth the most attractive offer they can while the user will have a bevy of information to select the best offer for their purchase. Throughout the purchase of homes, automobiles, etc. there are often multiple steps other than simply receiving and accepting the lender's terms. For example, depending on the purchase to be made, there may be bids for the attorney, appraisal, title, etc. The platform of the present invention allows for those in-network providers (platform registrants) to bid and allow users seeking those services to get the best price, while securing the business for the provider.

In some embodiments, the system has an interface configured for a lender to view on the display of an electronic device. The lender may view the user profile of the buyer and/or potential borrower and may submit to the buyer and/or potential borrower an offer of terms. The buyer and/or potential borrower may then review the at least one offer submitted by at least one lender and select the terms most favorable to the buyer and/or potential borrower. In one aspect, the lender will be able to view, on an interface of a display of an electronic device, other offers made to the buyer and/or potential borrower from other sources such as, by other lenders. This transparent viewing system allows lenders to cause a reverse bidding transaction and/or a modification of an offer of terms to be presented to a buyer and/or potential borrower to secure the buyer as a borrower for example, a mortgage.

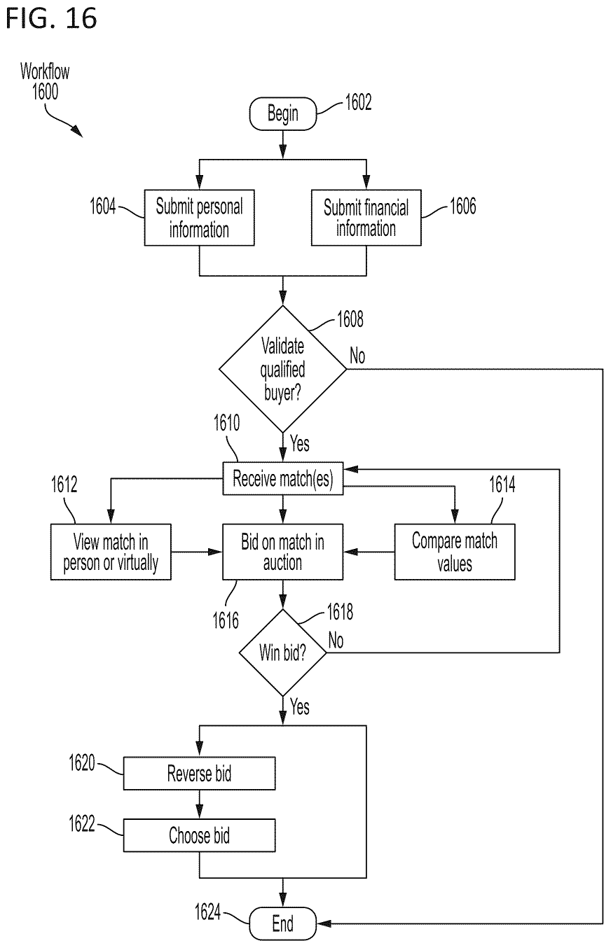

FIG. 16 shows a workflow 1600 for an online lending transaction and real estate auction system according to some embodiments. As discussed above, the system can instantiate workflows to perform any number of actions. In particular, at block 1602, workflow 1600 begins.

At block 1604, the user is asked to submit personal information to the system. At block 1606, the user is asked to submit financial information to the system. As discussed above, the system may be configured to validate a user as a qualified buyer (e.g., at block 1608). If the user is determined to be a qualified buyer, the system may be configured to show them at least one match (e.g., at block 1610). Before the auction, a user may be able to view their match virtually and/or in person (e.g., at block 1612). Before the auction a user may be able to compare the value of at least one match to the value of at least a second match (e.g., at block 1614). As discussed above, the user may be able to bid on their at least one match in an auction (e.g., at 1616). If the user wins the bid 1618 a lender, for example, may be able to reverse bid and compete for a user's business. The user may participate in a reverse bidding process to (e.g., at 1620) and choose a bid option that is most favorable (e.g., at 1622). Workflow 1600 ends at block 1624.

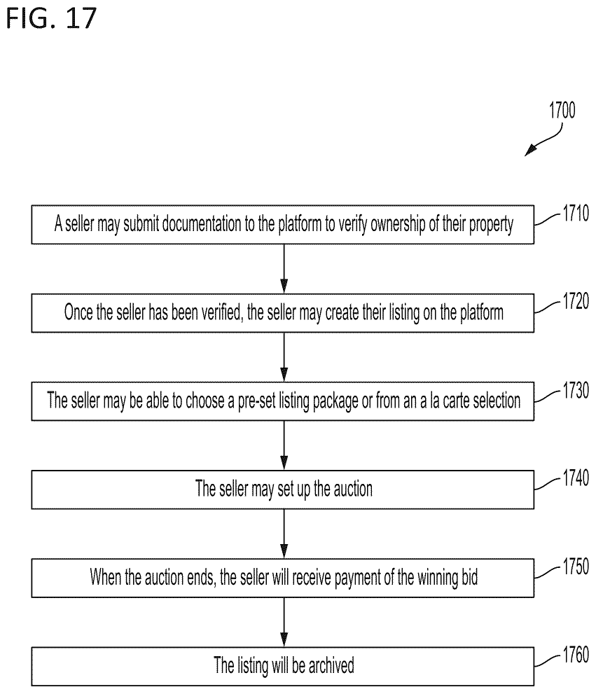

FIG. 17 illustrates a method 1700 of various actions that may be performed buy a seller in an online lending transaction and real estate auction system according to a nonlimiting embodiment of the present application. In some embodiments a seller may submit documentation to the platform to verify ownership of their property 1710. Once the seller has been verified, the seller may create their listing on the platform 1720. The seller may be able to choose a pre-set listing package or from an a la carte selection 1730. Such options may include but are not limited to virtual tours, staging, home showings with or without a home presenter, and professional photography. The seller may set up the auction 1740. The seller may be able to choose an auction date, duration of the auction, and set a starting bid. When the auction ends, the seller will receive payment of the winning bid 1750. The listing will be archived 1760.

In some embodiments, the direct-to-consumer model system may be configured for commerce at least in the energy, automotive, home renovation, and educational industries according to one embodiment of FIG. 1.

For example, in higher education, a user may view their at least one match on a mobile application or web application through a user interface. The at least one match may be colleges that the user has been accepted to. In some embodiments, the value of each match may be determined by an AI optimal matching model and an AI financial analysis model. The value of each match may indicate to a user to what extent their personal and financial goals compare to each respective match. For example, the system may consider data such as the average earnings for people with the specified degree, location of the college, as well as cost of tuition and living. The colleges that the user has been accepted to may reverse bid on the user's tuition and finance aid packages. Student loan lenders may also reverse bid on the user's student loan package.

For example, in the automotive industry, a user may be able to input their financial and personal information into the system. A user may be prompted to fill out a survey or upload documents representing their financial and personal information. For example, the system may consider data such as a user's preferred brand of car and preferred amenities. The user may view their at least one match on a mobile application or web application through a user interface. The at least one match may be cars. In some embodiments, the value of each match may be determined by an AI optimal matching model and an AI financial analysis model. The value of each match may indicate to a user to what extent their personal and financial goals compare to each respective match. The car dealerships or manufacturers that the user has been matched to may reverse bid on the user's automotive financing package (i.e., lease term, downpayment amount, etc.).

For example, in the energy industry, the system may be able to advise a user on converting to different energy sources. Energy sources may include renewable energy sources and nonrenewable energy sources (e.g., solar energy, geo-thermal energy, oil, and natural gas). The value of each match may be determined by an AI optimal matching model and an AI financial analysis model. The value of each match may indicate to a user to what extent their personal and financial goals compare to each respective match. For example, the system may consider data such as the location, the average temperature in the specified location, and cost of living in the specified location. Alternatively or additionally, the system may consider data such as current price in the commodities market, for example. The system may be configured to send automated notifications to a buyer indicating a new match. The automated notifications to the buyer may include details of the match indicating why a match may or may not provide value to a buyer. For example, a user may be looking to switch from a nonrenewable energy source to a renewable energy source and the market price for solar energy in the user's zip code has recently significantly decreased. The AI financial analysis model and the AI optimal matching model may determine that this match is a high value match and notify a user to take advantage of the change in market price. A user may request to be notified through text messaging, email services, automated phone calls, etc. The system may be further configured allow energy providers to reverse bid on the user's energy financing packages.

For example, in the home renovation industry, the system may be able to connect users with renovation providers. A user may be prompted to fill out a survey or upload documents representing their financial and personal information. For example, the system may consider data such as what form of renovations they would like (i.e., updated kitchen, new flooring, designing an outdoor deck, etc.). Alternatively or additionally, a user may access hologram technology through an API. The hologram technology may be able to create a design for a renovation. The system may be able to convert the design to an architectural plan and provide the user with the full materials list, estimated completion timeframes, and estimated overall costs. The user may view their at least one match on a mobile application or web application through a user interface. The at least one match may be renovation providers. In some embodiments, the value of each match may be determined by an AI optimal matching model and an AI financial analysis model. The value of each match may indicate to a user to what extent their personal and financial goals compare to each respective match. The renovation providers that the user has been matched to may reverse bid on the user's renovation project.

The AI financial analysis model may provide to the user real time indication if the match is high value, medium value, or low value to the student. In a further example, each match may be color coded green, yellow, or red to indicate if the match is of high value, medium value, or low value to the user, respectively. In yet a further example, a value list may be displayed to the buyer to detail why a match may or may not provide value to a buyer. In yet a further example, a value statement may be displayed to detail to the user reasons why a match may or may not provide value to a user. In yet a further example, both a first match and a second match may be displayed in a side-by-side comparison through the user interface.

The AI financial analysis model may provide to the user a real time affordability index. A real time affordability index may indicate to each user how a bid affects their personal finances. In some embodiments, each time a bid is placed in a reverse bid, a real time affordability index may be displayed on a user interface indicating an estimated payment for a user. Each bid may be color coded green, yellow, or red to indicate to the buyer if a bid is favorable, indifferent, or unfavorable to their personal finances. If an additional bid is made, the real time affordability index displayed on the user interface may additionally indicate the current payment for the additional bid.

The AI financial analysis module may be further configured for use in optimizing a user's personal finances. The AI financial analysis module may access the at least one finance database that may store data associated with a user's financial information. In some embodiments, the AI financial analysis module may make personalized recommendations to a user on actions they can take to reach their financial goals. For example, the AI financial analysis module may recommend to a user to move money in their 0.1% yield savings account to a high yield savings account. The system may be configured to allow banking providers to reverse bid on the user's yield amount. The system may be further configured to connect the user to a third-party system through an API to open their chosen high yield savings account. In a further example, the AI financial analysis module may analyze a user's spending and make recommendations on where a user can decrease their spending. If a user purchases take-out food 5 days a week, the financial analysis module may recommend that a user instead purchases take-out food only 2 days a week. The real time affordability index may indicate to the user how this change would affect their personal finances (e.g., a value indicating how much money they will save each month).

Various examples are methods that use the behavior of either or a combination of machines. Method examples are complete wherever in the world most constituent steps occur. For example, and in accordance with the various aspects and embodiments of the invention, IP elements or units include: processors (e.g., CPUs or GPUs), random-access memory (RAM—e.g., off-chip dynamic RAM or DRAM), a network interface for wired or wireless connections such as Ethernet, WIFI, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

Further, other embodiments of the platform or hub can be utilized for differing purposes under the purview of the present invention. For example, rather than purchasing a home, the process can be employed to allow a user to buy a new car, receive a home equity line of credit, etc. The embodiments of the present invention may be useful for any purchase in which financing, lending, and the like are to be utilized in the purchase of goods and/or services.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

When introducing elements of the present disclosure or the embodiments thereof the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A direct-to-consumer system for commerce, the system comprising:
at least one processor; and
a plurality of components executable by the at least one processor, the plurality of components comprising:
a lending application module configured to:
analyze financial data; and
determine a bidding approval amount;
an AI optimal matching module configured to:
match the financial data and personal data with a service provider;
an auction module configured to:
place a first bid from a buyer;
a reverse bidding module configured to:
place a second bid from a lender;
an AI financial analysis module configured to:
analyze a first financial decision of the first bid; and
analyze a second financial decision of the second bid.

2. The system of claim 1, wherein the lending application module is further configured to:
include an application programming interface configured to allow at least one third-party system to analyze the financial data and determine the bidding approval amount.

3. The system of claim 1, wherein the AI optimal matching module further comprises:
an AI optimal matching machine learning component configured to:
train an AI optimal matching machine learning model on:
the financial data;
the personal data;
associated matches;
an indication of a qualified buyer;
the bidding approval amount; and
third-party data from at least one third-party system.

4. The system of claim 3, wherein an output of the AI optimal matching machine learning model is stored in an optimal matching history database.

5. The system of claim 3, wherein an output of the AI optimal matching machine learning model is at least one match.

6. The system of claim 5, wherein the at least one match is displayed through a user interface.

7. The system of claim 5, wherein a first match and a second match are displayed in a side-by-side comparison through a user interface.

8. The system of claim 1, wherein an amount of the first bid is no more than the bidding approval amount.

9. The system of claim 1, wherein the reverse bidding module is further configured to:
select the bid from the lender.

10. The system of claim 3, wherein the AI financial analysis module is further configured to:
train an AI financial analysis machine learning model on:
at least one match output by the AI optimal matching machine learning model;
evaluation metrics;
effectiveness information; and
associated value.

11. A computer implemented method for execution of a direct-to-consumer system for commerce, the method comprising:
analyzing, by at least one processor, financial data;
determining, by the at least one processor, a bidding approval amount;
matching, by the at least one processor, the financial data and personal data with a service provider;
placing a first bid from a buyer;
analyzing, by the at least one processor, a first financial decision of the first bid;
placing a second bid from a lender; and
analyzing, by the at least one processor, a second financial decision of the second bid.

12. The method of claim 11, further comprising:
including an application programming interface configured to allow at least one third-party system to analyze the financial data and determine the bidding approval amount.

13. The method of claim 11, further comprising:
training an AI optimal matching machine learning model on:
the financial data;
the personal data;
associated matches;
an indication of a qualified buyer;
the bidding approval amount; and
third-party data from at least one third-party system.

14. The method of claim 13, further comprising storing an output of the optimal matching machine learning model in an optimal matching history database.

15. The method of claim 13, wherein an output of the matching is at least one match.

16. The method of claim 15, further comprising displaying the at least one match through a user interface.

17. The method of claim 15, further comprising displaying a first match and a second match in a side-by-side comparison through a user interface.

18. The method of claim 11, wherein an amount of the first bid is no more than the bidding approval amount.

19. The method of claim 11, further comprises selecting the bid from the lender.

20. The method of claim 11, further comprising:
training an AI optimal matching machine learning model on:
at least one match output by the AI optimal matching machine learning model;
evaluation metrics;
effectiveness information; and
associated value.

21. An online lending transaction and real estate auction system, comprising:
an application programming interface (i) gateway, comprising:
a transaction gateway server, the transaction gateway server, comprising:
a processor;
a memory;
a data storage;
a network interface configured for wireless communications;
a lender application module;
an auction module; and
an operating system, the operating system is in bidirectional communication with the lender application module and the auction module;
the processor is configured to execute steps for receiving, by the lender application module, a loan request initiated by a buyer of a selected real estate property, at least a portion of the loan request being real estate property data and buyer financial data;
the data storage is a non-transitory computer-readable medium having programming steps configured for execution on the processor to respond to the loan request, the data storage retains information, the information is configured for implementing at least one financial requirement to determine a value for a loan available of the loan request and a lender provider service based on a validation model from a financial institution;
an electronic device, the electronic device having a display, the display is configured to display to the buyer, an approval for the loan having the determined value; and
a graphic user interface, the graphic user interface is configured to receive input from the buyer.
